(19) United States
(12) Patent Application Publication
(10) Pub. No.: US 2005/0197021 A1
(43) Pub. Date: Sep. 8, 2005

(54) Encapsulated fabric material and method of making the same

(76) Inventor: Liora G. Manne, New York, NY (US)

Correspondence Address: Breiner & Breiner, L.L.C., P.O. Box 19290, Alexandria, VA, 22320-0290, US

(21) Appl. No.: 10/901,995

(22) Filed: Jul. 30, 2004

Related U.S. Application Data
(60) Provisional application No. 60/545,913, filed on Feb. 20, 2004.

(51) Int. Cl. B32B 27/12; B32B 27/04; B32B 5/02

(52) U.S. Cl. 442/64

(57) ABSTRACT

An encapsulated fabric material and method of making the same is described. Specifically, the encapsulated fabric material comprises a sheet of plastic affixed to each side of a fabric. A preferred type of plastic is polyvinyl chloride (PVC). A method of affixing a sheet of plastic to each side of a fabric is also described. In a preferred embodiment, each sheet of plastic is affixed to the fabric by an adhesive, such as glue. However, any suitable adhesive or adhesive method may be used to affix each sheet of plastic to the fabric. The material is then heat-pressed to seal the fabric and sheets of plastic together to form the encapsulated fabric material. The material may then be polished to clean the plastic and to provide a smooth, even finish to the material.

### RELATED APPLICATIONS

This application hereby claims the benefit under 35 U.S.C. § 119(e) of U.S. Provisional Application Ser. No. 60/545,913, filed Feb. 20, 2004, entitled ENCAPSULATED FABRIC MATERIAL AND METHOD OF MAKING THE SAME.

This application hereby incorporates by reference U.S. Pat. No. 5,003,674, entitled “NEEDLE FELTED FABRICS”, issued Apr. 2, 1991, in the names of Samuel Cohen and Liora G. Manne.

### FIELD OF INVENTION

The present invention relates to an encapsulated fabric material and method of making the same. Specifically, the present invention comprises a fabric encapsulated between two sheets of plastic, such as polyvinyl chloride (PVC). The method of the present invention comprises affixing a sheet of a plastic to each side of a fabric, heat pressing the material and polishing the material.

### BACKGROUND OF THE INVENTION

The fabric industry continually strives to develop various fabrics which are beautiful, durable, strong and flexible. As such, new types of fabrics and methods of making these fabrics are continually being developed. However, many fabrics may be strong and durable, but are not flexible or beautiful. As such, a need exists for a fabric material that is beautiful, durable, strong, flexible, capable of being utilized for various types of products and is easily manufactured. The present invention addresses the shortcomings of the prior art.

### OBJECTS AND SUMMARY OF THE INVENTION

The present invention is an encapsulated fabric material and method of making the same. Specifically, the present invention is an encapsulated fabric material comprising a fabric affixed between two sheets of plastic, such as polyvinyl chloride (PVC). The method of the present invention comprises affixing a sheet of plastic to each side of a fabric. In a preferred embodiment, the plastic is affixed to the fabric by glue, such as any suitable or conventionally known glue. However, any suitable adhesive or adhesive method may be used to affix each sheet of plastic to the fabric. The encapsulated fabric material is then heat-pressed to seal the fabric and sheets of plastic together to form the encapsulated fabric material. The encapsulated fabric material may then be polished to clean the plastic and provide a smooth, even finish to the material.

A primary object of the present invention is to provide a fabric encapsulated by plastic to form an encapsulated fabric material.

Another primary object of the present invention is to provide an encapsulated fabric material which is beautiful, strong, durable, flexible and capable of being used to make various types of products.

Another primary object of the present invention is to provide a method of making an encapsulated fabric material which is easy, efficient and effective.

### BRIEF DESCRIPTION OF DRAWINGS

Referring now to the drawings:

FIG. 1 is an exploded perspective view of the encapsulated fabric material of the present invention.

FIG. 2 is a side view of the encapsulated fabric material of the present invention.

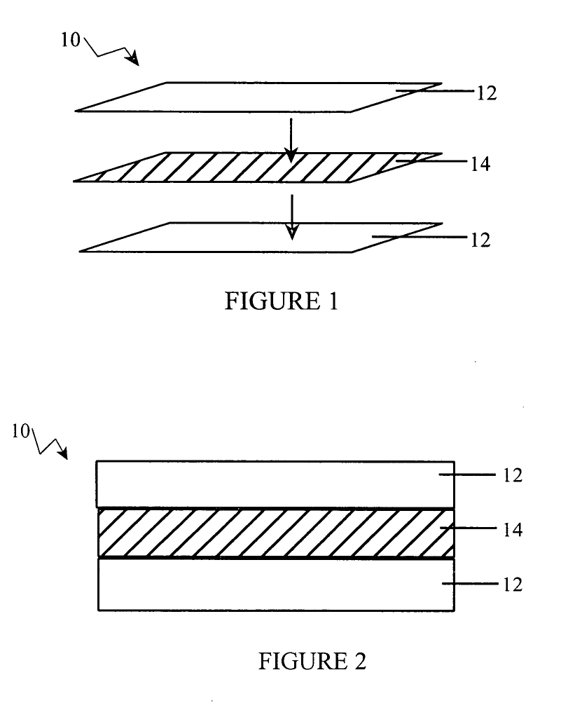

### DETAILED DESCRIPTION OF THE PREFERRED EMBODIMENTS

The present invention is an encapsulated fabric material 10 and method of making the same. Specifically, the present invention is an encapsulated fabric material 10 comprising a fabric 14 affixed between two sheets of plastic 12. In a preferred embodiment, the type of plastic used is polyvinyl chloride (PVC). However, any suitable plastic material may be used. The thickness of each sheet of plastic 12 may also vary depending on the end use of the encapsulated fabric material 10. For example, the thickness of each sheet of plastic 12 may vary between light-weight and heavy-weight. A light-weight plastic, i.e., less plastic is used and a thinner gauge, is preferably used when the encapsulated fabric material 10 is used to make flexible items such as, but not limited to, placemats and light shades. A heavy-weight plastic, i.e., more plastic is used and a thicker gauge, is preferably used when the encapsulated fabric material 10 is used to make more rigid items such as, but not limited to, plates and chandelier components.

While any suitable fabric may be utilized in the present invention, the preferred fabric is a needle felted fabric as disclosed and claimed in U.S. Pat. No. 5,003,674. For example, this patented fabric is specially created by blending and mixing custom dyed acrylic fibers to create intricate color designs. More particularly, the fabric is created by blending, layering, cutting and hand creating each design using special hand needles. Once a design is complete, high technology processing and needle punching transforms the material into a fabric by further blending and compressing the color fibers.

The method of the present invention comprises affixing a sheet of plastic 12 to each side of a fabric 14. In a preferred embodiment, each sheet of plastic 12 is affixed to the fabric 14 by glue, such as any suitable or conventionally known glue. However, any suitable adhesive or adhesive method may be used to affix each sheet of plastic 12 to the fabric 14. The material 10 is then heat-pressed to seal the fabric 14 and the sheets of plastic 12 together to form the encapsulated fabric material 10 of the present invention. The encapsulated fabric material 10 may then be polished to clean the plastic 12 and to provide a smooth, even finish to the material 10.

The encapsulated fabric material 10 is preferably used to make various products such as, but not limited to, handbags, wallets, clutches, cosmetic cases, shoes, sandals, placemats, coasters, light shades, plates, chandelier components and bookmarks. However, the encapsulated fabric material may be used to make any suitable product.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. An encapsulated fabric material comprising:
a fabric having a first side and a second side;
a first sheet of plastic affixed to said first side of said fabric; and
a second sheet of plastic affixed to said second side of said fabric,
wherein said first sheet of plastic, said fabric and said second sheet of plastic are sealed to form said encapsulated fabric material.

2. The encapsulated fabric material of claim 1, wherein said first sheet of plastic and said second sheet of plastic are polyvinyl chloride.

3. The encapsulated fabric material of claim 1, wherein said fabric is needle-felted fabric.

4. The encapsulated fabric material of claim 1, wherein said first sheet of plastic and said second sheet of plastic are affixed to said fabric by an adhesive.

5. The encapsulated fabric material of claim 4, wherein said adhesive is glue.

6. The encapsulated fabric material of claim 1, wherein said first sheet of plastic, said fabric and said second sheet of plastic are sealed by heat-pressing.

7. A method of making an encapsulated fabric material comprising:
affixing a first sheet of plastic to a first side of a fabric;
affixing a second sheet of plastic to a second side of said fabric;
heat-pressing said first sheet of plastic, said fabric and said second sheet of plastic together to seal said fabric and form said encapsulated fabric material; and
polishing said first sheet of plastic and said second sheet of plastic to clean said first sheet of plastic and said second sheet of plastic and to provide a smooth, even surface on said encapsulated fabric material.

8. The method of making an encapsulated fabric material of claim 7, wherein said first sheet of plastic and said second sheet of plastic are polyvinyl chloride.

9. The method of making an encapsulated fabric material of claim 7, wherein said fabric is needle-felted fabric.

10. The method of making an encapsulated fabric material of claim 7, wherein said first sheet of plastic and said second sheet of plastic are affixed to said fabric by an adhesive.

11. The method of making an encapsulated fabric material of claim 10, wherein said adhesive is glue.
